(19) United States
(12) Patent Application Publication
(10) Pub. No.: US 2022/0093072 A1
(43) Pub. Date: Mar. 24, 2022

(54) Acoustic Absorption

(71) Applicant: Ashmere Holdings Pty Ltd, Bayswater, Western Australia (AU)

(72) Inventor: Colin Ayres, Bayswater (AU)

(21) Appl. No.: 17/297,952

(22) PCT Filed: Nov. 29, 2019
(86) PCT No.: PCT/AU2019/051314

§ 371 Date: May 27, 2021

(30) Foreign Application Priority Data
Nov. 30, 2018 (AU) 2018904573

(51) Int. Cl. G10K 11/168; G10K 11/172; E04B 1/86; E04B 9/04; E04C 2/36; E04C 2/52; B32B 3/26; B32B 3/12; B32B 15/20; B32B 15/04; B32B 15/01

(52) U.S. Cl. CPC G10K 11/168; G10K 11/172; E04B 1/86; E04B 9/0442; E04B 9/0464; E04C 2/365; E04B 2001/8461; B32B 3/266; B32B 3/12; B32B 15/20; B32B 15/043; B32B 15/016; E04C 2/52

(57) ABSTRACT

An acoustic panel (for absorbing sound) includes a first sheet with spaced microperforations, a second sheet with microperforations more widely spaced than the microperforations of the first sheet, and a first cellular core sandwiched between the first sheet and the second sheet. The panel can be spaced from a surface, such as a wall. A second cellular core can be provided between the second sheet and a third sheet. The third sheet is preferably solid without microperforations but can have microperforations. Noise Reduction Coefficient (NRC) can be 0.8.

### FIELD OF THE INVENTION

The present invention relates to an acoustic panel of the type which includes at least one cellular core structure sandwiched between two face sheets.

The present invention also relates to a method of acoustic absorption using such a panel.

### BACKGROUND TO THE INVENTION

It is known to provide a panel which includes a honeycomb core structure defining a plurality of generally hexagonal shaped cells, and a face sheet adhesively bonded to each side of the honeycomb structure so as to sandwich the honeycomb structure in between the sheets. Such panels are in common use as internal walls, ceilings, floors and partitions in aircraft, ships, trains and buildings due to their low weight and high stiffness.

However, such panels provide very little absorption to incident sound. In order to improve the sound absorption characteristics of these panels, sound absorptive materials such as polymer foams and rock-wool have been used to cover or replace the panels. This increases weight and cost, and can also constitute a fire hazard. If the sound to be absorbed is of relatively low frequency, the sound absorptive materials need to be relatively thick.

An alternative arrangement for providing improved sound absorption is to use an alternative form of panel that has a perforated facing at which an acoustic wave is first incident on the panel. The perforations are holes of several millimetres diameter or more, the Open Area (provided by the holes) being significantly greater than 10% of the surface area of the overall facing.

Since the acoustic resistance of such large holes is very small, a porous sound absorption layer is used as a core material, placed behind the facing (e.g. Rockwool). The facing sheet with large perforation holes and large Open Area therefore is simply used to present the porous sound absorber to incident sound waves. As the peak absorption frequencies of the porous absorber are relatively high (greater than 1500 Hz), such acoustic panels are relatively ineffective for a relatively low frequency range (below 1000 Hz) where noise absorption is often most greatly needed.

It is possible to provide an acoustic absorption panel in a form having: (i) a microperforated facing; (ii) a non-perforated backing; and (iii) a cellular core structure extending from the microperforated facing to the non-perforated backing.

‘Microperforation’ is generally defined as holes having submillimetre diameter and very small overall open area (typically less than 5%). Panels of this form provide resonant ‘microperforated panel absorbers’ and may find application in aircraft engine nacelles as shaped components. Microperforated flat panels may find application as internal walls, ceilings, and partitions in aircraft, ships, trains and buildings. Other applications include use in machinery enclosures and cleanrooms.

By employing microperforated panel absorbers, advantageous acoustic absorption can be provided, without the use of any fibrous materials. Acoustic absorption can be provided at relatively low frequencies and at relatively low weight, which is difficult to achieve with conventional fibrous materials. It may also be possible to classify them as Non-Combustible.

The cell depth of the cellular core structure has a profound effect on the acoustic frequencies that can be absorbed. Deep cell depths absorb relatively low frequencies, whereas shallow cell depths absorb relatively high frequencies.

Microperforated panel absorbers are usually highly effective over a relatively narrow waveband corresponding to their microperforated sheet thickness, hole diameter, open area and cell depth.

It would be advantageous to provide a microperforated acoustic absorption panel having improved absorption characteristics i.e. greater broadband absorption than standard microperforated panels, or to at least provide the public with a useful choice.

### SUMMARY OF THE INVENTION

With the aforementioned in mind, an aspect of the present invention provides an acoustic panel for absorbing sound, the acoustic panel including at least a first sheet having spaced microperforations, a second sheet having microperforations more widely spaced than the microperforations of the first sheet, and a first cellular core sandwiched between the first sheet and the second sheet.

The microperforations create an ‘open area’ in a respective sheet. The open area is a function of microperforation (hole) diameter and spacing of the microperforations in the respective sheet. Closer spacing (higher density) of the microperforations of a given diameter increases the open area for that sheet. Wider spacing (lower density) of the microperforations of a given diameter decreases the open area for that sheet. Increasing the diameter of the microperforations increases the open area.

It will be appreciated that the open area of a sheet is very small compared to the overall face area of the sheet. The proportion of open area to overall sheet face (open area %) is affected as soon as hole diameter changes (i.e. larger or smaller) or hole spacing changes. Open areas are typically less than 5% of the overall sheet face area, so small changes in hole diameter significantly affect peak frequency absorption characteristics, allowing the panel to be tailored to absorb desired peak frequencies.

The open area has a profound effect on the acoustic frequencies that can be absorbed by the microperforated panel. Assuming constant cell depth; small open areas (wide hole spacing and/or relatively very small hole diameter) absorb relatively low frequencies, compared with large open areas (small hole spacing and/or relatively larger hole diameter) which absorb relatively high frequencies.

The diameter and spacing of the microperforations, in combination with cell depth, can advantageously be tailored for the panel to absorb desired acoustic frequencies.

The present invention can incorporate microperforations of selected diameter, selected spacing and/or selected cell depth(s), into the same unitary panel, with or without an airgap behind the panel when in use, to absorb multiple desired peak frequencies.

The first sheet may be a facing sheet to first receive incident acoustic waves to be absorbed by the panel.

The second sheet may provide a rear sheet of the panel. In such an embodiment, the second sheet is microperforated and the panel may be mounted spaced from a surface, such as a wall or ceiling. The surface may preferably be an existing surface or may be a surface applied over an existing surface.

Preferably the second sheet may be spaced at a predetermined and/or specific distance from the surface.

The depth of such a space between the second sheet of the panel and the adjacent surface (wall, floor or ceiling) can be important in determining the low-frequency absorption of the acoustic panel. The greater the overall depth, the more absorption at lower frequencies.

The open area created by the microperforations in the first sheet (facing sheet) may be larger than the open area created by the microperforations of the second sheet.

The microperforations of the first sheet may be at a smaller spacing distance from each other than the microperforations of the second sheet.

The microperforations may provide a larger open area of the first sheet than a respective open area provided by the microperforations of the second sheet, the open area of each said sheet determined by diameter and/or spacing of the respective microperforations.

The larger open area of the first sheet may be substantially provided by closer spacing of the microperforations of the first sheet compared to respectively wider spacing of the microperforations of the second sheet.

The first sheet may include at least some of the microperforations of a different diameter compared to the diameter of at least some of the microperforations of the second sheet.

The diameter of the at least some microperforations of the first sheet may be larger than the diameter of the at least some microperforations of the second sheet.

Preferably, the acoustic panel includes up to around or substantially half as many microperforations per unit area (e.g. per m²) through the second sheet than there are microperforations per unit area (e.g. per m²) through the first sheet.

Preferably, the acoustic panel includes up to substantially less than half as many microperforations per unit area (e.g. per m2) through the second sheet than there are microperforations per unit area (e.g. per m2) through the first sheet.

Preferably there is at least one microperforation in the first sheet for every cell in the first cellular core.

Preferably approximately half as many microperforations per unit area (e.g. per m²) may be provided in the second sheet as the number of cells per unit area (e.g. per m²) in the first cellular core, and more preferably whatever the respective hole/microperforation diameters are in the first and second sheets.

Preferably the acoustic panel further includes a third sheet spaced from the first sheet and the second sheet such that the second sheet is intermediate between the first sheet and the third sheet, and a second cellular core is between the second sheet and the third sheet.

The cells of the first cellular core may be the same or smaller in diameter than cells of the second cellular core.

The cells of the first cellular core may be of smaller depth to absorb relatively higher frequency acoustic waves in combination with the first sheet, than a total thickness of the panel (or panel plus airgap behind the third sheet if the third sheet is microperforated) in combination with the microperforated second sheet.

Some (preferably approximately or substantially half) of the cells of the first cellular core may be closed at their bases, such as by the second microperforated sheet. For example, the holes/microperforations in the second sheet may be more widely spaced than the diameter of the honeycomb cells in the first cellular core.

Approximately or substantially 50% of the cells in the first cellular core may be closed at their bases and approximately or substantially 50% of the cells in the first cellular core may be open at their bases, corresponding to the spacing of microperforations of the second sheet and the diameters of the cells in the first cellular core.

The diameter and depth of the cells of the first cellular core and the diameter and depth of the cells of the second cellular core may be selected in combination with choices of the microperforations of the first and second sheets, to absorb different peak frequencies.

The respective microperforations may be between 0.1 mm and 2.0 mm diameter, preferably between 0.1 mm and 1.0 mm diameter, more preferably between 0.3 mm and 0.8 mm diameter. Most preferably 0.8 mm diameter.

The cells of the respective first or second cellular core may be bonded (e.g. by adhesive) to a respective internal face of the respective sheet.

The acoustic panel may include a third sheet spaced from the first sheet and the second sheet.

The third sheet may include microperforations. Alternatively and preferably, the third sheet may have no microperforations.

The third sheet may include a rear sheet of the panel. In one or more embodiments where the third sheet has no microperforations, the acoustic panel does not need to be spaced from a solid surface to absorb low frequencies—the third sheet constitutes the solid surface integral to the panel and a second cellular core provides the spacing between the second microperforated sheet and the solid (non-microperforated) backing.

Preferably, the acoustic panel includes a second cellular core sandwiched between the third sheet and the second sheet.

The acoustic panel may be a double core sandwich panel having the first cellular core sandwiched between the first and the second sheet, and the second cellular core sandwiched between the second sheet and the third sheet.

Preferably cells of the first cellular core may be the same or smaller in diameter than cells of the second cellular core.

The structure of the first cellular core and the second cellular core may include a number of respective primary cells and a number of respective secondary cells; the respective secondary cells having an increased cell depth in comparison to the respective primary cells.

The cells of the first cellular core having no microperforations through to a said second cellular core or space may be termed ‘primary cells’.

At least some of the cells of the first cellular core may be connected by microperforations through the second sheet to cells of the second cellular core or air space behind the panel. These can be termed secondary cells i.e. the depth of the first cellular core, through the respective microperforations where present in the second sheet, plus the depth of the cells of the second cellular core, or the first cellular core plus space to the solid surface behind (wall/ceiling).

Preferably, the first and second cellular cores may be similar in depth/thickness.

Preferably the first sheet and/or the second sheet may be between 0.2 mm and 1.0 mm thick, more preferably between 0.3 mm and 0.8 mm, and yet more preferably approximately or substantially 0.8 mm thick.

The third and any subsequent sheets may or may not be of the same thickness as the first sheet or the second sheet.

Preferably, the first sheet and/or the second sheet (and preferably any subsequent sheet(s)) may be approximately or substantially the same thickness as the diameter of the microperforation through the respective sheet.

It will be appreciated that the relatively shallow depth of the first cellular core (primary cells) may absorb relatively higher frequency acoustic waves, in combination with a microperforated facing (first sheet) with relatively large open area (relatively high density of microperforations compared to the density of microperforations of the second sheet).

The cell diameter of cells of the first cellular core, and the spacing of microperforations in the second sheet are chosen so as to provide approx. 50% of the cells in the first cellular core with a solid base—thus creating the primary cell depth. Sound absorption of relatively high frequencies may be achieved by the microperforations of the first sheet being closer spaced than the spacing of the microperforations of the second sheet, combined with the relatively shallow depth of the primary cells compared to the greater depth of the secondary cells.

The remaining cells, approximately 50% of cells, in the first cellular core have a microperforation hole in their base, creating a connection thru to the second cellular core or space—thus creating the secondary cell depth (the full depth of the first and second cellular cores combined, or the first cellular core plus space to wall/ceiling).

Sound absorption of relatively low frequencies may be achieved by the microperforations of the second sheet being spaced more widely than the microperforations of the first sheet, which results in a reduced open area, combined with the relatively deeper secondary cells (e.g. combined depth of primary and secondary cellular cores, or combined depth of primary cellular core and rear airgap).

The cells of the first cellular core (primary cells) may extend from the internal facing of the first microperforated sheet to a first internal facing of the second microperforated sheet.

The cells of the second cellular core may extend from a second internal facing of the second microperforated sheet to an internal facing of the third sheet, which may be microperforated or solid.

Preferably the cells of the respective cellular cores are bonded, such as adhered, to the respective facings of the respective sheets.

Preferably the first microperforated sheet in combination with the primary cell depth preferentially absorbs acoustic waves of a desired relatively high peak frequency.

Preferably the second microperforated sheet in combination with secondary cell depth preferentially absorbs acoustic waves of a desired relatively low peak frequency.

Preferably, acoustic wave (sound) absorption of the peak frequency absorbed by the first microperforated sheet and associated cellular core, and the peak frequency of the second microperforated sheet and associated cellular core/airgap both lie in the range of 250 Hz to 4 kHz

Preferably the cells of the first cellular core provide a primary cell depth when their bases are blocked, such as by the second microperforated sheet (primary cells), and the cells of the first and second cellular cores combined preferably provide a secondary cell depth when microperforation holes in the second sheet link/connect together cells in the first and second cellular core layers, or link/connect together cells in the first cellular core with the rear space (secondary cells).

Preferably the primary cellular core and the secondary cellular core are each of the same general shape and size.

The secondary cellular core can have larger cell diameter if required, to save weight and/or cost.

Preferably the cells of the primary cellular core and the secondary cellular core are substantially hexagonally shaped. The first cellular core and the second cellular core may each be termed a ‘honeycomb’ core due to the arrangement of cells, preferably being hexagonal cells.

At least some of the microperforations in the respective sheet may preferably be spaced apart from each other in 60 degree orientation, 45 degree orientation or 90 degree orientation.

According to another aspect of the present invention there is provided a microperforated panel absorber comprising: a first sheet, a second sheet and a first cellular core structure therebetween; the first sheet having microperforations; the second sheet having more widely spaced microperforations; the cellular core structure having primary cells.

The microperforations in the first sheet provide acoustic passages leading into all the cells provided by the first cellular core structure

The microperforations in the second sheet may provide acoustic passages either leading out of the acoustic panel into a space, or into cells of a second cellular core structure, depending on the diameter of the cells in the first cellular core structure and the spacing of the microperforation holes in the second sheet.

Preferably approx 50% of the cells in the first cellular core can be provided with a microperforation hole at their base, thereby converting approx. half of the cells in the first cellular core from primary cells into secondary cells having much greater depth and much lower open area, thereby providing an additional absorption peak at lower frequency.

Appropriate first cellular core cell diameter, and first and second microperforated sheet hole spacings can be provided such that desired relatively high and relatively low frequencies can simultaneously be absorbed by a single panel structure comprising first and second microperforated sheets, first and second cellular cores, and third non-perforated sheet; or a single core layer panel comprising first and second microperforated sheets, and first cellular core, with a known depth of space behind.

For a desired higher frequency to be absorbed, the Open Area of the microperforated first sheet and primary cell depth (depth of the first cellular core structure) can be determined/calculated.

For the desired lower frequency to be absorbed, the Open Area of the microperforated second sheet and the secondary cell depth (total depth/thickness of the first and second cellular cores plus second microperforated sheet, or total depth/thickness of the first cellular core plus second microperforated sheet plus space behind) can be determined/calculated.

The cell diameter of the first cellular core is preferably such that there are approximately twice as many cells per unit area (e.g. per m²) in the first cellular core as the number of microperforations per unit area (e.g. per m²) in the second sheet. Thereby, approximately half of the cells in the first cellular core preferably have solid bases (creating primary cells), and half are linked to the second cellular core, or space, behind the second microperforated sheet (creating secondary cells).

For a panel containing three microperforated sheets, the second sheet can be configured so as to provide bases to ⅓ of the cells of the first cellular core, and the third sheet can be configured so as to provide bases to ½ of the cells of the second cellular core; thereby providing ⅓ of total panel area for each of the 3 microperforated sheets and associated cellular cores to absorb their three desired peak frequencies.

It is to be noted that there is no need to have the microperforations and individual cells in either the first or second cellular core perfectly in register.

It need not matter where exactly the microperforations intersect the cell tops or bottoms. Some of the microperforations in the second sheet are inevitably blocked by cell walls and associated adhesives, but this is a small and reasonably constant % and can be allowed for in calculations.

It is also to be noted that some microperforations are inevitably partially blocked by cell walls or associated adhesives. This is also a small and reasonably constant percentage (%) and can be allowed for in calculations. Partial blocking of some microperforations/holes is actually advantageous to broaden each absorption peak.

The acoustic panel including the first and second microperforated sheets and the first cellular core may be mounted spaced from a surface to the rear of the acoustic panel. The space may be used to contribute to the lower frequency sound absorption of the panel.

Another aspect of the present invention provides a method of absorbing sound including absorbing a peak frequency of sound with the first microperforated sheet and the primary cells of the first cellular core, and absorbing another (lower) peak frequency of sound with the second microperforated sheet and the secondary cells of the linked first and second cellular cores (linked by microperforation holes in the second sheet), or the linked first cellular core and the space between the rear of the acoustic panel and the surface behind (again linked by microperforation holes in the second sheet).

A further aspect of the present invention provides a method of absorbing multiple sound frequencies by employing a first microperforated sheet in association with a primary cell depth of a first cellular core to absorb one relatively high peak frequency of the sound, and a second microperforated sheet in association with a secondary cell depth provided by the first cellular core in combination with a second cellular core, or the first cellular core and an airgap, to additionally absorb a second relatively low peak frequency.

A further aspect provides a method of providing an acoustic panel for acoustic absorption including: providing a first sheet having microperforations, providing a second sheet having microperforations and sandwiching a first cellular core between the first sheet and the second sheet.

The method may include providing a third sheet and a second cellular core sandwiched between the third sheet and the second sheet

The third sheet may include microperforations leading to a tertiary cell or airgap, absorbing a third peak frequency, and so on.

Preferably a surface area of the first sheet having the microperforations is at least 5% of the surface area of the first sheet, preferably at least 20%, more at least preferably 30%, yet more preferably at least 50%, even more preferably at least 75% and still more preferably at least 95%.

Preferably the surface area of the microperforated second/secondary sheet overlying the secondary cells is between 25 to 75% of the surface area of the front sheet. More preferably 50%.

Approximately or substantially twice as many or more said microperforations/holes per unit area (e.g. per m²) may be provided in the first sheet than in the second sheet.

Preferably, twice as many per unit area (e.g. per m²) may be the minimum number of microperforations/holes in the first sheet compared to the second sheet.

At least some of the microperforations in the first sheet may be of a different diameter compared to the diameter of at least some of the microperforations of the second sheet.

At least some of the microperforations in the first sheet may be of the same diameter compared to the diameter of at least some of the microperforations of the second sheet.

At least one microperforation in the first sheet may be provided for every cell in the first cellular core.

Approximately half as many microperforations per unit area (e.g. per m²) may be provided in the second sheet as the number of cells per unit area (e.g. per m²) in the first cellular core, whatever the respective microperforation diameters are in the first and second sheets.

A third sheet may be provided spaced from the first sheet and the second sheet such that the second sheet is intermediate between the first sheet and the third sheet, and a second cellular core is between the second sheet and the third sheet.

The cells of the first cellular core may be provided of smaller depth to absorb relatively higher frequency acoustic waves in combination with the first sheet, than a total thickness of the panel in combination with the microperforated second sheet and first & second cellular core, or first cellular core and airgap.

Approximately or substantially 50% of the cells in the first cellular core may be closed at their bases.

Approximately or substantially 50% of the cells in the first cellular core may be open at their bases corresponding to the spacing of microperforations of the second sheet.

One or more embodiments of the present invention involves bonding the cells of the respective first or second cellular core to respective internal faces of the respective sheets.

It is to be recognised that other aspects, preferred forms and advantages of the present invention will be apparent from the present specification including the detailed description, drawings and claims.

There is no intention to limit the present invention to the specific embodiments shown in the drawings. The present invention is to be construed beneficially to the applicant and the invention given its full scope.

### BRIEF DESCRIPTION OF THE DRAWINGS

One or more embodiments of the present invention will hereinafter be described with reference to the accompanying drawings, in which:

FIG. 1 shows a known single layer honeycomb core acoustic panel with microperforations in a facing sheet and a solid rear sheet. NB. Perforation holes are shown perfectly in register with underlying cells for convenience only. There is no necessity to specifically align the microperforations of the sheets with the cells in any particular manner.

FIG. 2 shows a side sectional view of a single layer cellular core acoustic panel spaced from a solid rear surface such as a wall or ceiling, according to an embodiment of the present invention.

NB: microperforations in both the first and second microperforated sheets are shown perfectly in register with honeycomb cells in the cellular core layer for convenience only. There is no necessity to align first or second microperforated sheets with the cells in any particular way.

FIG. 3 shows an exploded view of a single layer cellular core acoustic panel with perforated front and rear sheets, according to an embodiment of the present invention.

FIG. 4a shows a side sectional view of a double cellular core acoustic panel with non-perforated rear (third) sheet, according to a further embodiment of the present invention.

FIG. 4b shows a side sectional view of a double cellular core acoustic panel with microperforated rear (third) sheet according to a further embodiment of the present invention.

FIG. 5 shows a graph of acoustic absorption from test results for an example of a known acoustic panel having one microperforated (front) face, a non-perforated back face and a single honeycomb cellular core sandwiched therebetween.

FIG. 6 shows a graph of test results of acoustic absorption for a dual core layer acoustic panel according to an embodiment of the present invention.

FIG. 7 shows a graph of test results of acoustic absorption for a single core layer acoustic panel with airgap behind, according to a further embodiment of the present invention.

FIG. 8 shows a graph of test results of acoustic absorption for a dual core layer acoustic panel according to a further embodiment of the present invention, optimised to give high Noise Reduction Coefficient (0.8).

FIG. 9 shows a graph of acoustic absorption from test results of an example of a known acoustic panel having a zone of reduced depth within part of the cellular core of the panel.

FIG. 10 shows a graph of absorption for a panel according to an embodiment of the present invention having first and second microperforated sheets bonded to each side of a first cellular core, with airgap behind, showing a clear double peak of absorption as tested to ASTM C423-08 standard in comparison with a variety of non-perforated honeycomb panels.

ASTM C423-08 is a standard test method for sound absorption and sound absorption coefficients by the reverberation room method.

FIG. 11 shows only panels Ayre #4, Ayres #5 and Ayres #6 from FIG. 11.

### DESCRIPTION OF PREFERRED EMBODIMENT

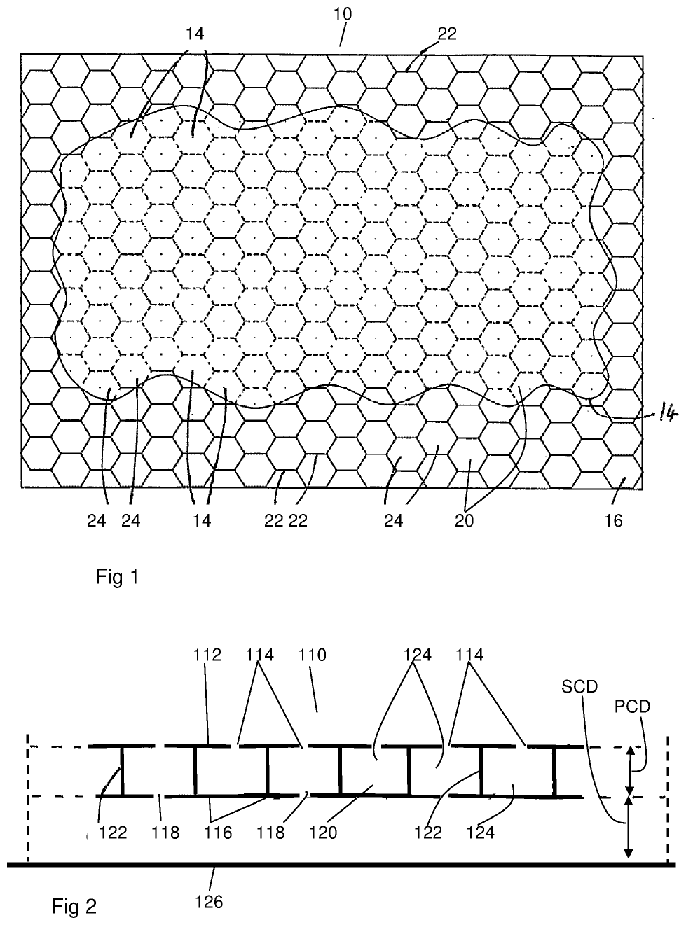

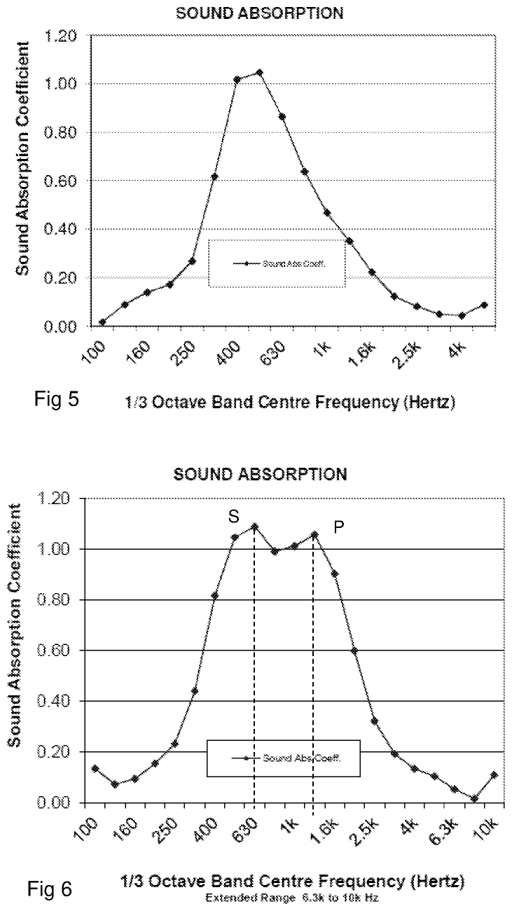

FIG. 1 shows a known single core layer acoustic panel 10 having a facing sheet 12 with microperforations 14 (e.g. FIG. 5).

The panel 10 is backed by a solid rear sheet 16. A honeycomb core 20 is sandwiched between the facing and rear sheets. The core has cells 24 defined by cell walls 22. Each microperforation 14 enables sound to pass to one of the cells underlying the respective microperforation. Such a panel has absorption at and around a single peak frequency due to the fixed cell size and single central microperforation per cell.

FIG. 2 shows a side sectional view of an embodiment of the present invention. An acoustic panel 110 for absorbing sound includes a first sheet 112, a second sheet 116, a single layer cellular core 120 sandwiched therebetween and a solid surface 126 to the rear across an airgap (e.g. FIG. 8). Primary Cell Depth (PCD) and Secondary Cell Depth (SCD) are indicated. Preferably the The first sheet has microperforations 114 through to cells 124 of the cellular core 120. Each cell is defined by at least one cell wall 122.

The acoustic panel has a second sheet 116 with microperforations 118 at a greater spacing between the microperforations than the spacing of the microperforations of the first sheet. It will be appreciated that the microperforations in the second sheet are at a greater spacing than the respective spacing of the microperforations of the first sheet.

Spacing of the microperforations 114 need not be limited to only one perforation per cell. Spacing of the microperforations 118 preferably should be such that only half of the cells 124 have a respective perforation at their bases.

For one or more forms of the present invention, the microperforations in the first sheet and the microperforations in the second sheet (and/or in any third sheet etc.), may be of the same diameter. Alternatively, the microperforations in one said sheet may be of a different diameter to the microperforations in any other said sheet.

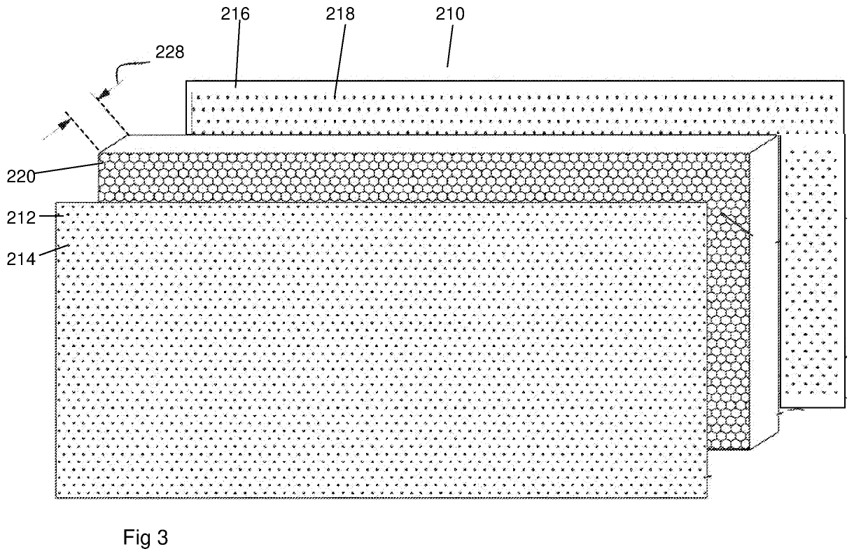

FIG. 3 shows an exploded view of an acoustic panel 210 according to an embodiment of the present invention. A first (facing) sheet 212 has microperforations 214. A second (rear) sheet 216 has microperforations 218 at a larger spacing between perforations than that of the first sheet.

A cellular core 220, having a thickness 228, is provided intermediate the first sheet 212 and the second sheet 216. In a finished product, the first sheet and the second sheet would each be bonded to the core.

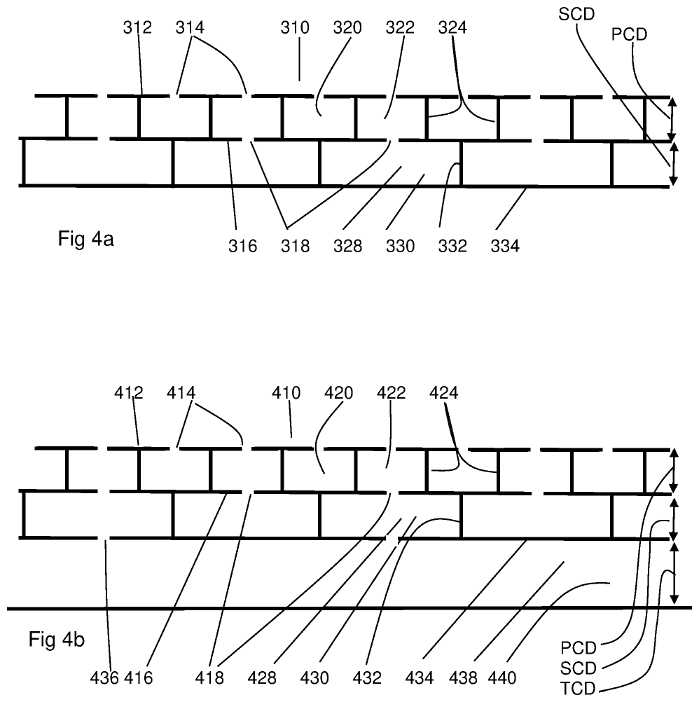

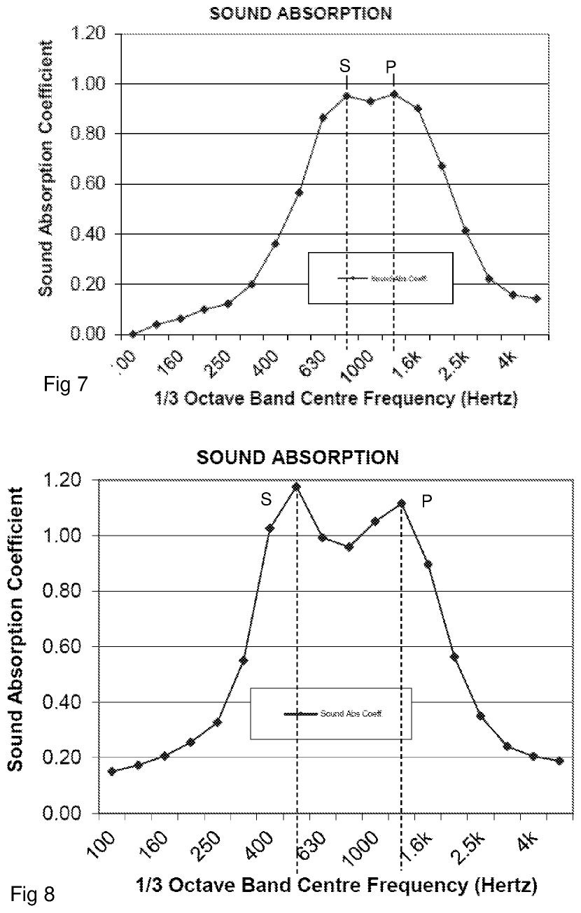

FIG. 4a shows a side sectional view of a double core layer acoustic panel 310 for absorbing sound according to an embodiment of the present invention (e.g. FIG. 7).

The panel includes a first sheet 312 having microperforations 314, second sheet 316 also with microperforations 318, the first and second sheets sandwiching therebetween a cellular core 320 of cells 322. Each cell has at least one cell wall 324 and a cell depth (Primary Cell Depth ‘PCD’ or first cell depth).

The microperforations of the second sheet (which can be termed an intermediate sheet or layer or septum/septum sheet) are spaced at greater distances apart than the microperforations of the first sheet.

A second cellular core 328 having cells 330 with a least one cell wall 332 can be sandwiched between the second (intermediate) layer and a third sheet or rear layer 334. Each cell 330 has a cell depth (Secondary Cell Depth ‘SCD’ or second cell depth).

Preferably the third sheet is solid without perforations. However, it will be appreciated that the acoustic panel can have more layers of cellular core and intermediate microperforated sheets to selectively absorb more sound frequencies.

For example, FIG. 4b shows an embodiment of the acoustic panel 410 present invention having two layers of cellular core with a rear (third) sheet 434 with microperforations 436 therethrough to connect to an open space/air gap 438 to a solid surface 440 behind the acoustic panel.

The acoustic panel 410 includes a first sheet 412 having microperforations 414, second sheet 416 also with microperforations 418, the first and second sheets sandwiching therebetween a cellular core 420 of cells 422. Each cell has at least one cell wall 424.

A second cellular core 428 has cells 430 with a least one cell wall 432 can be sandwiched between the second (intermediate) sheet and a third sheet or rear layer 434.

The third sheet or rear layer/sheet 434 includes microperforations 436.

The cells 422 provide a primary or first cell depth (Primary Cell Depth ‘PCD’). The cells 428 provide a secondary or second cell depth (Secondary Cell Depth ‘SCD’). The open space/air gap between the rear (third) sheet 434 and the surface 440 behind the acoustic panel provides a tertiary or third cell depth (Tertiary Cell Depth ‘TCD’).

Preferably the open area provided by the microperforations at the rear of the acoustic panel is smaller than the open area of the first sheet and of the second sheet.

FIG. 5 shows by way of comparative example test results of acoustic frequency absorption for a known single layer honeycomb core acoustic panel having a microperforated front sheet and a solid back/rear sheet.

The panel is in this embodiment is 40 mm thick, with a 0.9 mm thick microperforated aluminium face panel and a solid (non-microperforated) 0.3 mm thick rear sheet with a single layer aluminium honeycomb core. The noise reduction coefficient (NRC) tested as 0.5.

Test results for the panel relating to FIG. 5 were as shown in Table 1 below:

TABLE 1

| ⅓ Octave | RT for | RT for room | Sound |
|---|---|---|---|
| Centre Frequency | Empty Room | with Sample | Absorption |
| Hz | Sec. | Sec. | Coefficient |
| 100 | 4.4 | 4.3 | 0.02 |
| 125 | 6.4 | 4.7 | 0.09 |
| 160 | 6.5 | 5.0 | 0.14 |
| 200 | 7.9 | 5.5 | 0.17 |
| 250 | 8.6 | 4.9 | 0.27 |
| 315 | 8.7 | 3.2 | 0.62 |
| 400 | 8.4 | 2.2 | 1.02 |
| 500 | 7.8 | 2.2 | 1.05 |
| 630 | 6.8 | 2.4 | 0.86 |
| 800 | 5.7 | 2.6 | 0.64 |

| | | | | |
|---|---|---|---|---|
| 1 | k | 4.5 | 2.7 | 0.47 |
| 1.25 | k | 4.1 | 2.8 | 0.35 |
| 1.6 | k | 3.7 | 2.9 | 0.22 |
| 2 | k | 3.4 | 3.0 | 0.12 |
| 2.5 | k | 3.4 | 3.1 | 0.08 |
| 3.15 | k | 3.1 | 3.0 | 0.05 |
| 4 | k | 2.7 | 2.6 | 0.04 |
| 5 | k | 2.2 | 2.1 | 0.09 |

FIG. 6 shows a graph of test results of acoustic absorption for an acoustic panel according to an embodiment of the present invention.

The embodiment the subject of the test results represented by FIG. 6 is a panel with a front facing sheet of a particular hole spacing/open area of microperforation, an inner second sheet (e.g. septum layer) of a wider hole spacing/smaller open area, to that of the first sheet, and a non-perforated third sheet (rear/back face).

The acoustic panel tested has a 40 mm overall thickness (OT) with microperforated facing (first) sheet and microperforated intermediate (second) sheet with a solid rear (third) sheet, all of aluminium. The two cellular cores are honeycomb style cores, preferably of aluminium.

In this embodiment, the test results provide an absorption graph having two absorption peaks (Primary P and Secondary S); one a higher frequency peak corresponding to the facing hole size & spacing (open area) and upper cellular core cell depth (first or Primary cell depth ‘PCD’), and the lower frequency peak corresponding to the intermediate (septum) second sheet hole size & spacing (open area) and total panel depth (second or Secondary Cell Depth SCD).

The second microperforated sheet of FIG. 6 is the same as the first microperforated sheet of FIG. 5, giving a similar low frequency peak.

The first microperforated sheet of the FIG. 6 panel has a much higher open area than the second microperforated sheet which, combined with the shallower depth of the primary cells, results in the additional higher peak frequency compared to FIG. 5—thereby dramatically increasing Noise Reduction Coefficient (NRC) from 0.5 to 0.7.

The test results yielded the following tabulated data (Table 2) represented in the graph of FIG. 6 for a 40 mm thick, dual cellular core (honeycomb), acoustic panel of aluminium sheets and aluminium cellular core, with a nil space behind the acoustic panel:

TABLE 2

| ⅓ Octave | RT for | RT for room | Sound |
|---|---|---|---|
| Centre Fequency | Empty Room | with Sample | Absorption |
| Hz | Sec. | Sec. | Coefficient |
| 100 | 4.9 | 4.1 | 0.13 |
| 125 | 5.6 | 5.0 | 0.07 |
| 160 | 6.8 | 5.6 | 0.09 |
| 200 | 8.6 | 6.1 | 0.15 |
| 250 | 9.5 | 5.6 | 0.23 |
| 315 | 9.2 | 4.0 | 0.44 |
| 400 | 8.6 | 2.6 | 0.82 |
| 500 | 8.1 | 2.2 | 1.05 |
| 630 | 7.2 | 2.0 | 1.09 |
| 800 | 5.8 | 2.0 | 0.99 |

| | | | | |
|---|---|---|---|---|
| 1 | k | 4.9 | 1.9 | 1.01 |
| 1.25 | k | 4.1 | 1.7 | 1.06 |
| 1.6 | k | 3.8 | 1.8 | 0.90 |
| 2 | k | 3.6 | 2.1 | 0.60 |
| 2.5 | k | 3.3 | 2.5 | 0.32 |
| 3.15 | k | 3.0 | 2.5 | 0.19 |
| 4 | k | 2.6 | 2.3 | 0.13 |
| 5 | k | 2.0 | 1.9 | 0.10 |
| 6.3 | k | 1.6 | 1.6 | 0.05 |
| 8 | k | 1.2 | 1.2 | 0.02 |
| 10 | k | 0.9 | 0.9 | 0.11 |

The results show a significant increase in Noise Reduction Coefficient (NRC). The overall NRC is 0.70, being an improvement in noise reduction over the 0.5 NRC panel of FIG. 5.

Utilising one or more embodiments of the present invention, the absorption peaks can be tailored using a mathematical model, so that acoustic panels can be tailored to absorb particular frequencies. Further layers of perforated intermediate sheets and cellular cores of other sized cells can be added, absorbing more peak frequencies.

For example, the first microperforated sheet of the FIG. 6 panel has a much higher open area than the second microperforated sheet which, combined with the shallower depth of the primary cells, results in the additional higher peak frequency—thereby dramatically increasing Noise Reduction Coefficent (NRC) from 0.5 to 0.7.

The low frequency peak of the test results shown in the graph of FIG. 7 is produced by the same second microperforated sheet and second cell depth or secondary cell depth (SCD) (labelled S) as the peak low frequency of FIG. 6 (which is also the same first microperforated sheet and cell depth of FIG. 5).

Absorption of both peak frequencies (relating to the first or primary dell depth ‘PCD’ labelled P, and the second or secondary cell depth ‘SCD’ labelled S) of FIG. 8 are slightly reduced compared to FIG. 6, which both have the same first and second microperforated sheets, and the peak low frequency is shifted slightly to higher frequency as a consequence of using an airgap behind the panel instead of an additional layer of cellular core. These results show a reduction in noise reduction coefficient (NRC) to 0.60 for this 20 mm thick panel (with 20 mm airgap behind) compared to the 40 mm thick double-layer panel of FIG. 6. However NRC is still higher than the single-layer 40 mm panel of FIG. 5 (NRC=0.50).

FIG. 8 shows by way of comparative example test results of acoustic frequency absorption for a dual layer honeycomb core acoustic panel having a microperforated front sheet, a microperforated septum/intermediate sheet and a solid back/rear sheet, similar to the subject panel of FIG. 6 with first and second microperforated sheets modified for high NRC.

The panel is 40 mm thick overall, with 0.8 mm thick microperforated aluminium facing and septum sheets and a solid (non-microperforated) 0.3 mm rear sheet with a honeycomb core (preferably of aluminium) between the facing and septum sheet and a second honeycomb core (preferably of aluminium) between the septum sheet and the rear sheet. The noise reduction coefficient (NRC) tested as 0.8.

Test results for the panel relating to FIG. 8 are as shown in Table 3 below:

TABLE 3

| ⅓ Octave | RT for | RT for room | Sound |
|---|---|---|---|
| Centre Fequency | Empty Room | with Sample | Absorption |
| Hz | Sec. | Sec. | Coefficient |
| 100 | 4.8 | 4.0 | 0.15 |
| 125 | 5.9 | 4.6 | 0.17 |
| 160 | 7.9 | 5.4 | 0.21 |
| 200 | 9.0 | 5.4 | 0.26 |
| 250 | 9.2 | 4.9 | 0.33 |
| 315 | 8.9 | 3.6 | 0.55 |
| 400 | 8.1 | 2.3 | 1.03 |
| 500 | 7.4 | 2.0 | 1.18 |
| 630 | 6.3 | 2.2 | 0.99 |
| 800 | 5.3 | 2.1 | 0.96 |

| | | | | |
|---|---|---|---|---|
| 1 | k | 4.5 | 1.8 | 1.05 |
| 1.25 | k | 4.0 | 1.7 | 1.11 |
| 1.6 | k | 4.0 | 1.9 | 0.90 |
| 2 | k | 3.7 | 2.3 | 0.56 |
| 2.5 | k | 3.3 | 2.5 | 0.35 |
| 3.15 | k | 2.9 | 2.5 | 0.24 |
| 4 | k | 2.5 | 2.2 | 0.20 |
| 5 | k | 1.9 | 1.8 | 0.19 |

In particular, FIG. 8 shows a graph of test results of acoustic absorption for an acoustic panel according to a preferred embodiment of the present invention. The embodiment the subject of the test results represented by FIG. 8 is a panel with a front facing sheet of a particular hole spacing/open area of microperforation, an inner second sheet (e.g. septum layer) of a wider hole spacing/smaller open area, to that of the first sheet, and a non-perforated third sheet (rear/back face).

In this embodiment, the test results provide an absorption graph having two absorption peaks; one a higher frequency (S) peak corresponding to the facing hole size & spacing (open area) and upper cellular core cell depth, and the lower frequency (P) peak corresponding to the intermediate (septum) second sheet hole size & spacing (open area) and total panel depth. The spacing of the microperforations in the first (facing) sheet is 6.0 mm and the second (septum) sheet is 13.25 m, with 9.5 mm diameter honeycomb cells in both cell layers and a non-perforated rear face.

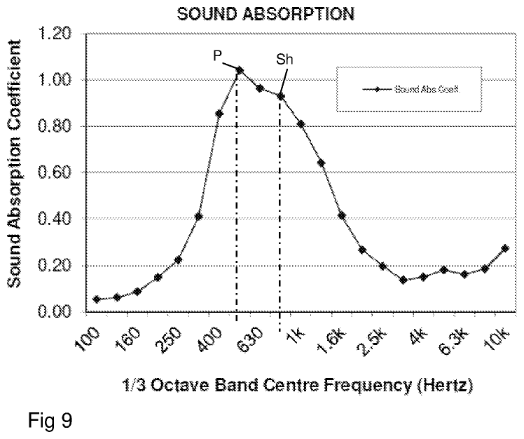

FIG. 9 shows a graph of acoustic absorption from test results of an example of an existing acoustic panel having a single microperforated facing (first) sheet and a zone of reduced depth within part of the cellular core of the panel giving two peaks of absorption—one peak at a lower frequency corresponding to full honeycomb cell depth, and a second peak at a higher frequency corresponding to reduced cell depth.

In the panel under test in respect of FIG. 9, the reduced depth area was produced by inserting a higher-density section of honeycomb having a non-perforated sheet on the lower side, this is crushed into the upper surface of the lower-density honeycomb cellular core of the “mother panel” during panel manufacture.

The panel was of 40 mm overall thickness with a 0.7 mm thick microperforated aluminium facing panel. NRC was tested as 0.6.

The graph of absorption in FIG. 9 shows a shoulder (Sh) on the high frequency side of the primary peak P, compared to a standard panel—resulting in increased Noise Reduction Coefficient (NRC) compared to a standard panel of FIG. 5.

According to at least one embodiment of the present invention, three sheets (3 planes) are separated from each other by two respective layers of honeycomb (aluminium or other material) cellular core, one cellular core between the front (facing) first sheet and the second (intermediate) sheet, and the second cellular core between the second (intermediate) sheet and the third (rear/back) sheet.

It will be appreciated that the present invention can have more than three sheets and more than two cores, and the rear sheet of the acoustic panel can be solid or microperforated, depending on the required application.

The spacing of the microperforations is preferably such that at least one microperforation of the facing (first) sheet leads to each and every individual cell within the first cellular core.

The spacing of the microperforations within the intermediate (second) sheet is preferably such that each perforation leads from only approximately 50% of the cells of the first cellular core into the cells of the second cellular core e.g. secondary cells. Other proportions of the cells are possible, such as between 80% and 20%, depending on the required application and sound frequencies to be absorbed.

The cell diameter of the first cellular core (upper layer, say) is preferably the same or smaller than the cell diameter of the second cellular core.

Preferably, approximately 50% of all of the cells of the first cellular core (upper cells) are closed at their bases, and the other 50% of the upper cells have holes (microperforations) at their bases leading to the respective cells of the second cellular core. Each successive core from the first to the second to the third, and so on, may need cells of increasing diameter compared to the previous core.

Preferably the spacing of the microperforations in the first (facing) sheet is between 2 mm and 20 mm, more preferably between 3 mm and 15 mm, yet more preferably between 5 mm and 10 mm. By way of example, an embodiment of the present invention was subjected to testing and provided the test result graph shown in FIG. 6.

An alternative embodiment of the present invention provides an acoustic panel having a microperforated first (facing) sheet, a microperforated second (rear) sheet, and a cellular core sandwiched therebetween.

Such a ‘single core layer’ panel having microperforated facing and rear sheets is particularly, though not solely, suited for applications where there will be a surface behind the acoustic panel, such as a wall, ceiling or rear sheet of another panel.

Such a ‘single core layer’ acoustic panel absorbs two peak frequencies as does the two layer version of the present invention; a higher frequency corresponding to the microperforated facing hole size & spacing and the depth of the honeycomb, and a lower frequency corresponding to the microperforated back face hole size and spacing and the combined depth of the ‘honeycomb’ panel and space to the surface behind the acoustic panel.

The test results yielded the following tabulated data (Table 4) represented in the graph of FIG. 9 for a 20 mm thick, single cellular core (honeycomb), acoustic panel of microperforated facing and rear aluminium sheets and an aluminium cellular core, with a 20 mm space behind the acoustic panel:

TABLE 4

| ⅓ Octave | RT for | RT for room | Sound |
|---|---|---|---|
| Centre Fequency | Empty Room | with Sample | Absorption |
| Hz | Sec. | Sec. | Coefficient |
| 100 | 4.5 | 4.7 | 0.00 |
| 125 | 5.4 | 5.2 | 0.04 |
| 160 | 6.8 | 6.2 | 0.06 |
| 200 | 8.5 | 6.9 | 0.10 |
| 250 | 8.8 | 6.7 | 0.12 |
| 315 | 9.2 | 6.0 | 0.20 |
| 400 | 8.9 | 4.5 | 0.36 |
| 500 | 8.2 | 3.4 | 0.57 |
| 630 | 7.1 | 2.5 | 0.86 |
| 800 | 5.8 | 2.2 | 0.95 |

| | | | | |
|---|---|---|---|---|
| 1 | k | 4.8 | 2.0 | 0.93 |
| 1.25 | k | 4.4 | 1.9 | 0.96 |
| 1.6 | k | 4.0 | 1.9 | 0.90 |
| 2 | k | 3.8 | 2.1 | 0.67 |
| 2.5 | k | 3.6 | 2.5 | 0.41 |
| 3.15 | k | 3.1 | 2.6 | 0.22 |
| 4 | k | 2.7 | 2.5 | 0.16 |
| 5 | k | 2.2 | 2.1 | 0.14 |

Table 5 below shows a comparison of basic specifications for various honeycomb core panels subjected to absorption testing.

TABLE 5

| | Panel | | |
|---|---|---|---|
| Panel | Thickness | Weight | |
| number # | (mm) | Kg/m² | Description |
| 1 | 10 | 4.86 | Non-perforated decorative |
| | | | laminate both sides |
| 2 | 20 | 5.37 | Non-perforated decorative |
| | | | laminate both sides |
| 3 | 10 | 3.41 | Non-perforated aluminium both |
| | | | sides |
| 4 | 20 | 3.96 | Non-perforated aluminium both |
| | | | sides |
| 5 | 20 | 7.79 | Micro perforated aluminium |
| | | | facing, solid back |
| 6 | 20 | 5.78 | Micro perforated aluminium |
| | | | both sides |

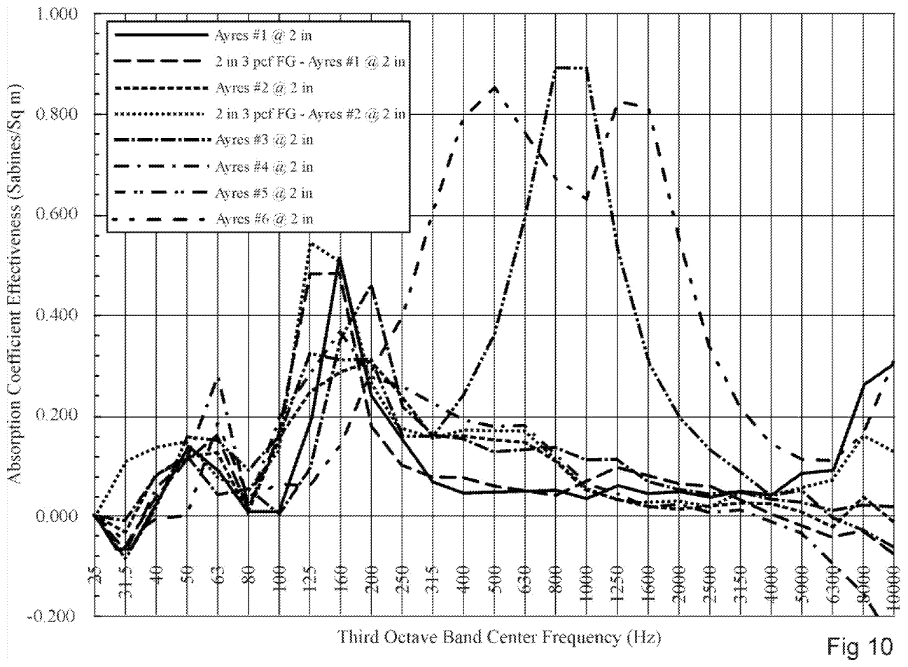

As shown in Table 5, six different types of panel were tested, panels #1 to #6. The panels had a range of thicknesses, constructions and finishes. The results are shown in the graphs in FIG. 10.

All six panels were installed covering a bare bulkhead. Two of the panels (#1 and #2) were retested with the addition of two inches of 3 pcf fibreglass placed between the bulkhead and the panel.

FIG. 10 shows results of testing on panels #1 to #6 conducted to ASTM C423-08.

Those test results show single peak improvement in absorption for panel #5, having microperforations on one side, and double peak improvement in absorption coefficient for mid-range frequencies for the acoustic panel with microperforations on both sides plus an airgap behind the panel, panel #6.

The chart of FIG. 10 shows peaks exhibiting significant absorption between 500 Hz and 1600 Hz for microperforated panels #5 and #6 being much higher than the other non-perforated panels in the test.

The microperforated sheets and core depths used in the double peak panel matched those used in FIG. 7, except the airgap to the rear of the panel was 50 mm instead of 20 mm.

It can be seen that the high frequency peak remained close to 1600 Hz, whereas the low frequency peak shifted from 800 Hz to 500 Hz due to the higher secondary cell depth (total depth of panel and airgap).

Table 6 below shows the Absorption Coefficient values at various frequencies (left hand column) for panels #1 to #6 as reflected in the graph shown in FIG. 10. The Ayres #6 panel has two spaced layers of perforated sheets and shows two absorption peaks in the chart, per at least one embodiment of the present invention.

In the legend in FIG. 10, “2 in 3 pcf FG—Ayres #1 @ 2 in” is the “Ayres #1 @ 2 in” non-perforated panel with 2 inches of 3 lb/ft³ fibreglass in the 2 inch airgap behind the panel, and “2 in 3 pcf FG—Ayres #2 @ 2 in” is the “Ayres #2 @ 2 in” non-perforated panel with 2 inches of 3 lb/ft³ fibreglass in the 2 inch in the airgap behind the panel.

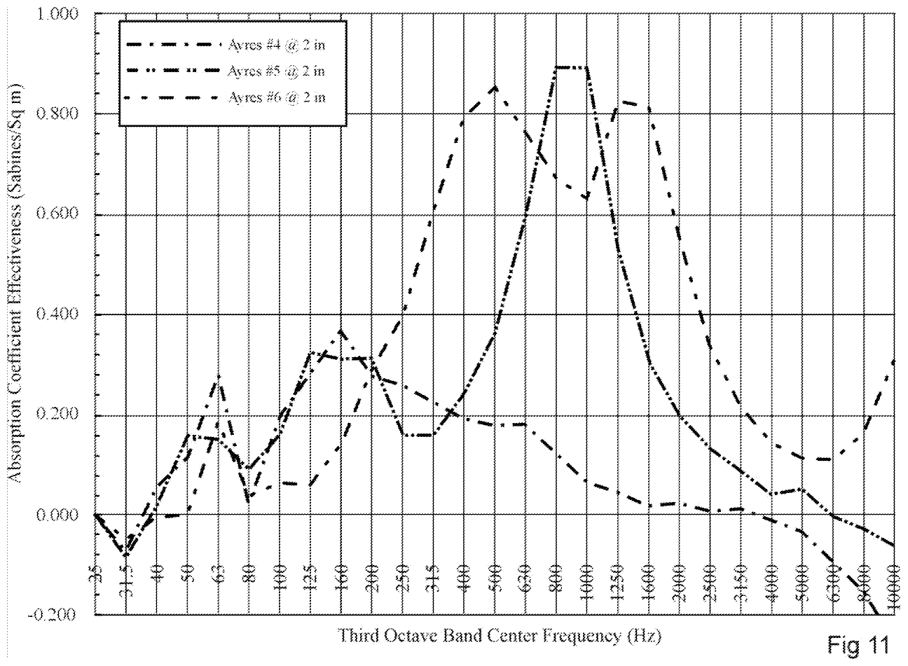

FIG. 11 shows only the traces for Ayres #4, Ayres #5 and Ayres #6 panels from Table 6 and FIG. 10, the Ayres #6 panel having the aforementioned two spaced layers of perforated sheets and showing two absorption peaks in the chart.

TABLE 6

| | Ayres | 2 in 3 pcf | Ayres | 2 in 3 pcf | Ayres #3 | Ayres | Ayres | Ayres #6 |
|---|---|---|---|---|---|---|---|---|
| | #1 @2 in | FG-Ayres | #2 @2 in | FG-Ayres | @2 in | #4 @2 in | #5 @2 in | @2 in |
| Test | Absorp | #1 @2 in | Absorp | #2 @2 in | Absorp | Absorp | Absorp | Absorp |
| Freq | Coeff | Absorp Coeff | Coeff | Absorp Coeff | Coeff | Coeff | Coeff | Coeff |
| (Hz) | Sab/m\hat{ }2 | Sab/m\hat{ }2 | Sab/m\hat{ }2 | Sab/m\hat{ }2 | Sab/m\hat{ }2 | Sab/m\hat{ }2 | Sab/m\hat{ }2 | Sab/m\hat{ }2 |
| 25 | | | | | | | | |
| 31.5 | −0.073 | −0.066 | −0.029 | 0.110 | −0.008 | −0.074 | −0.089 | −0.049 |
| 40 | 0.028 | 0.037 | 0.081 | 0.138 | 0.083 | 0.056 | 0.018 | −0.004 |
| 50 | 0.137 | 0.111 | 0.120 | 0.149 | 0.126 | 0.117 | 0.160 | 0.001 |
| 63 | 0.093 | 0.161 | 0.127 | 0.077 | 0.042 | 0.282 | 0.153 | 0.187 |
| 80 | 0.008 | 0.025 | 0.008 | 0.050 | 0.056 | 0.021 | 0.091 | 0.038 |
| 100 | 0.007 | 0.163 | 0.159 | 0.131 | 0.003 | 0.198 | 0.162 | 0.064 |
| 125 | 0.182 | 0.480 | 0.248 | 0.546 | 0.096 | 0.289 | 0.324 | 0.061 |
| 160 | 0.517 | 0.486 | 0.286 | 0.506 | 0.352 | 0.368 | 0.311 | 0.142 |
| 200 | 0.242 | 0.179 | 0.312 | 0.260 | 0.466 | 0.277 | 0.314 | 0.289 |
| 250 | 0.164 | 0.098 | 0.240 | 0.174 | 0.219 | 0.259 | 0.159 | 0.398 |
| 315 | 0.068 | 0.077 | 0.157 | 0.153 | 0.162 | 0.223 | 0.160 | 0.606 |
| 400 | 0.046 | 0.075 | 0.161 | 0.173 | 0.155 | 0.192 | 0.242 | 0.794 |
| 500 | 0.046 | 0.057 | 0.151 | 0.168 | 0.128 | 0.178 | 0.363 | 0.855 |
| 630 | 0.050 | 0.051 | 0.149 | 0.169 | 0.134 | 0.181 | 0.591 | 0.768 |
| 800 | 0.051 | 0.043 | 0.108 | 0.115 | 0.137 | 0.120 | 0.891 | 0.672 |
| 1000 | 0.034 | 0.061 | 0.053 | 0.056 | 0.111 | 0.064 | 0.891 | 0.630 |
| 1250 | 0.062 | 0.098 | 0.035 | 0.032 | 0.113 | 0.045 | 0.535 | 0.827 |
| 1600 | 0.046 | 0.085 | 0.019 | 0.026 | 0.068 | 0.018 | 0.304 | 0.813 |
| 2000 | 0.046 | 0.064 | 0.013 | 0.030 | 0.052 | 0.023 | 0.199 | 0.551 |
| 2500 | 0.038 | 0.060 | 0.021 | 0.018 | 0.046 | 0.008 | 0.133 | 0.337 |
| 3150 | 0.048 | 0.036 | 0.027 | 0.047 | 0.046 | 0.014 | 0.088 | 0.215 |
| 4000 | 0.044 | 0.006 | 0.026 | 0.041 | 0.034 | −0.011 | 0.040 | 0.142 |
| 5000 | 0.085 | −0.020 | 0.009 | 0.058 | 0.028 | −0.033 | 0.052 | 0.114 |
| 6300 | 0.092 | −0.041 | −0.022 | 0.073 | 0.012 | −0.091 | −0.004 | 0.112 |
| 8000 | 0.260 | −0.027 | 0.038 | 0.162 | 0.023 | −0.152 | −0.027 | 0.166 |
| 10000 | 0.303 | −0.075 | −0.013 | 0.128 | 0.018 | −0.261 | −0.064 | 0.310 |

1. An acoustic panel for absorbing sound, the acoustic panel comprising:
at least a first sheet having spaced microperforations;
a second sheet having microperforations more widely spaced than the microperforations of the first sheet; and
a first cellular core sandwiched between the first sheet and the second sheet.

2. The acoustic panel of claim 1, wherein the microperforations provide a larger open area of the first sheet than a respective open area provided by the microperforations of the second sheet, the open area of each said sheet determined by diameter and/or spacing of the respective microperforations.

3. The acoustic panel of claim 2, wherein the larger open area of the first sheet is substantially provided by closer spacing of the microperforations of the first sheet compared to respectively wider spacing of the microperforations of the second sheet.

4. The acoustic panel of claim 3, wherein the first sheet includes at least some of the microperforations of a different diameter compared to the diameter of at least some of the microperforations of the second sheet.

5. (canceled)

6. The acoustic panel of claim 1, wherein there are substantially half as many microperforations per unit area through the second sheet than there are microperforations per unit area through the first sheet.

7. The acoustic panel of claim 6, wherein there is at least one microperforation in the first sheet for each said cell in the first cellular core.

8. The acoustic panel of claim 6, wherein there are approximately half as many microperforations per unit area in the second sheet as the number of cells per unit area in the first cellular core, whatever the respective microperforation diameters are in the first and second sheets.

9. The acoustic panel of claim 1, further including a third sheet spaced from the first sheet and the second sheet such that the second sheet is intermediate between the first sheet and the third sheet, and a second cellular core is between the second sheet and the third sheet.

10. The acoustic panel of claim 1, wherein the cells of the first cellular core are the same or smaller in diameter than cells of the second cellular core.

11. The acoustic panel of claim 1, wherein the cells of the first cellular core are of smaller depth to absorb relatively higher frequency acoustic waves in combination with the microperforated first sheet, than a total thickness of the panel in combination with the microperforated second sheet.

12. The acoustic panel of claim 1, wherein approximately 50% of the cells in the first cellular core are closed at their bases, or wherein approximately 50% of the cells in the first cellular core are open at their bases corresponding to the microperforations of the second sheet.

13. (canceled)

14. (canceled)

15. The acoustic panel of claim 1, wherein the respective microperforations are between 0.1 mm and 2.0 mm diameter, preferably between 0.1 mm and 1.0 mm diameter, more preferably between 0.3 mm and 0.8 mm diameter.

16. The acoustic panel of claim 1, wherein the cells of the respective first or second cellular core are bonded to a respective internal face of the respective sheet.

17. (canceled)

18. (canceled)

19. A method of absorbing multiple sound frequencies by employing a first microperforated sheet in association with a primary cell depth of a first cellular core to absorb a peak (high) frequency of sound, and a second microperforated sheet in association with a secondary cell depth provided by the first cellular core in combination with a second cellular core, or the first cellular core and an airgap, to additionally absorb a second (low) peak frequency.

20. The method of claim 19, including providing a larger open area of the microperforations of the first sheet than the microperforations of the second sheet.

21. The method of claim 19, including connecting a proportion of the cells of the first cellular core to cells of the second cellular core or by connecting a proportion of the cells of the first cellular core to a space between the second sheet and a rear surface to provide an increased resonance depth, the connecting provided by the microperforations in the second sheet.

22. The method of claim 21, including connecting approximately or substantially 50% of the cells of the first cellular core to respective cells of the second cellular core or to the space between the second sheet and the rear surface.

23. The method of claim 19, wherein at least twice as many said microperforations are provided per unit area in the first sheet than in the second sheet.

24. The method of claim 19, including providing at least some of the microperforations in the first sheet of a different diameter compared to the diameter of at least some of the microperforations of the second sheet.

25. (canceled)

26. The method of claim 19, including providing at least some of the microperforations in the first sheet of the same diameter compared to the diameter of at least some of the microperforations of the second sheet.

27. The method of claim 19, including providing at least one microperforation in the first sheet for each respective said cell in the first cellular core, and providing approximately half as many microperforations per unit area in the second sheet as the number of cells per unit area in the first cellular core, whatever the respective microperforation diameters are in the first and second sheets.

28. (canceled)

29. The method of claim 19, including providing a third sheet spaced from the first sheet and the second sheet such that the second sheet is intermediate between the first sheet and the third sheet, and a second cellular core is between the second sheet and the third sheet.

30. The method of claim 19, including providing the cells of the first cellular core of smaller depth in combination with the first sheet to absorb relatively higher frequency acoustic waves than a total thickness of the panel in combination with the microperforated second sheet.

31. The method of claim 19, including providing approximately 50% of the cells in the first cellular core closed at their bases, or providing approximately 50% of the cells in the first cellular core open at their bases corresponding to the microperforations of the second sheet.

32. (canceled)

33. (canceled)

34. A microperforated panel absorber comprising: a first sheet, a second sheet and a first core structure therebetween; the first sheet having microperforations; the second sheet having microperforations; the first core structure having primary cells.
